(19) United States
(12) Patent Application Publication
(10) Pub. No.: US 2010/0247003 A1
(43) Pub. Date: Sep. 30, 2010

(54) Package Having Resealable Closure And Method Of Making Same

(75) Inventors: Scott Huffer, Hartsville, SC (US); Benjamin Davis, Columbia, SC (US); Angela Hurst Adams, Hartsville, SC (US)

Correspondence Address: FLASTER/GREENBERG P.C.;Four Penn Center, 1600 John F. Kennedy Boulevard, 2nd Floor, PHILADELPHIA, PA, 19103, US

(73) Assignee: Sonoco Development, Inc., Hartsville, SC (US)

(21) Appl. No.: 12/729,570

(22) Filed: Mar. 23, 2010

Related U.S. Application Data
(60) Provisional application No. 61/164,211, filed on Mar. 27, 2009.

(51) Int. Cl. B65D 65/28; B32B 37/04; B65D 33/16

(52) U.S. Cl. 383/207; 428/35.2; 156/309.6; 383/211

(57) ABSTRACT

A flexible package is provided having a side panel with an inner surface that is fixedly sealed to the inner surface of a second side panel. A pressure-sensitive adhesive is disposed between the sealable material of one side panel and the outer ply or layer of the side panel. A separation line is provided within the sealable material adjacent the fixed seal. The sealable material from the first side panel separates from the pressure-sensitive adhesive upon application of an opening force transverse to the fixed seal. The sealable material from the first panel remains sealed to the sealable material on the opposing surface of the second panel upon release. The release of the sealable material from its associated panel causes exposure of the pressure-sensitive adhesive. The exposed pressure-sensitive adhesive forms a reclosable seal for the ends of the first and second panels.

### RELATED APPLICATIONS

The present application claims the benefit of the filing date of U.S. provisional application No. 61/164,211, filed Mar. 27, 2009.

### FIELD OF THE INVENTION

The present invention relates to a flexible package having a heat sealed closure and a reclosable or resealable closure associated with the heat sealed closure.

### BACKGROUND OF THE INVENTION

Packages are used to retain product for storage and shipment. Flexible packages are often utilized to retain product. The flexible packages are sealed, for freshness and preservation of the product, and have various means for opening the package to expose the product. Often, it is desirable to provide a resealable mechanism for preserving the unused portion of the product after initial opening.

Various types of mechanisms have been developed for reclosing or resealing a flexible package. Many of these mechanisms are separately manufactured articles, which are added to the package either in a subsequent manufacturing step or by the consumer, such as zippers, reclosable tapes or tabs, seal strips, clips and the like.

The challenge in making a closure mechanism having an adhesive for resealing the package lies in the strength of the seal. An adhesive suitable for forming the original package seal, which must have sufficient strength to prevent inadvertent opening of the package during shipment and must be maintained closed during storage, is generally different from the type of adhesive used for resealing. Cold seals, hot melts and heat seals provide good sealing strength and, thus, are suitable for forming the original or “permanent” package seal. Unfortunately, such materials do not generally have sufficient reseal capability. Pressure-sensitive adhesives can be repeatedly opened and reattached to suitable substrates and, thus, are suitable for creating a resealable closure. Pressure-sensitive adhesives typically do not provide sufficient closure strength to be reliable as an original package seal.

U.S. Pat. No. 5,382,472 to Yanidis et al. shows a resealable package formed by side-by-side coextrusion of pressure-sensitive adhesives and polymers to make straight lined areas that cause a rupture of the materials during opening of a heat seal. The heat seal layer within the laminate ruptures through to the adhesive layer and then delaminates from the adhesive layer, exposing the pressure-sensitive adhesive and providing a resealable surface.

U.S. Pat. No. 6,517,243 to Huffer et al. shows a flexible package with a closure tab formed as part of the outer layer of the bag laminate. The tab is formed by precision die cut or laser score of the outer layer in the area of a pressure-sensitive adhesive applied between the laminate layers. Separation of the tab portion from the outer wall of the laminate exposes the pressure-sensitive adhesive, which adheres to the inside surface of the tab.

U.S. Pat. No. 6,076,969 to Jaisle et al. shows a flexible package having a resealable closure formed by applying a layer of pressure-sensitive adhesive on the inner surface of at least one of the opposing portions of the package. A layer of cohesive is applied to the inner surface of the opposing layers, with the pressure-sensitive adhesive covered by a layer of cohesive. The pressure-sensitive adhesive has a greater affinity for the cohesive than for the inner surface of the package. When the opposing portions of the package are pulled apart, the pressure-sensitive adhesive is detached from the inner surface of the package (adhering to the cohesive bond). The exposed pressure-sensitive adhesive permits the opened package to be selectively resealed.

U.S. Pat. No. 6,502,986 to Bensur et al. shows a package having a resealable portion foamed adjacent a permanent seal at one end of the package. A pressure-sensitive adhesive is applied to the inner surface of one laminate layer. Heat seal coating members are applied over the pressure-sensitive adhesive. The heat seal members are then sealed by heat and pressure. When the two sides of the package are pulled apart during opening, heat seal coating separates and exposes the pressure-sensitive adhesive. The heat seal coating member may then be pressed against the opposing side of the package having the pressure-sensitive adhesive for resealing.

US 2005/0276525 to Hebert et al. shows a flexible package formed from a laminate having a built-in opening and reclose feature within a side wall of the package. Offset score lines are separately formed in the laminate layers to enable the opening of a flap portion on the outer layer and the simultaneous opening of a package opening formed in the inner layer and covered by the flap. A pressure-sensitive adhesive is exposed by the flap, when opened, adjacent the opening formed by the inner layer within the offset score lines.

### SUMMARY OF THE INVENTION

The present invention relates to a sealing structure having a first panel with first and second surfaces. The first panel includes a sealable material defining at least a portion of the first surface. Within the first panel, a pressure-sensitive adhesive is provided between the sealable material of the first surface and the second surface material within the region of a fixed seal. A separation line is provided within the sealable material covering the pressure-sensitive adhesive. The separation line is positioned adjacent the fixed seal. A second panel is provided with an engaging surface having a sealable material thereon for forming the fixed seal with the sealable material of the first panel. The separation line for the sealable material of the first surface initiates separation of the adjacent parts of the sealable material upon application of an opening force to the fixed seal. The release of the sealable material exposes the pressure-sensitive adhesive. The sealable material of the first surface remains sealed to the sealable material within the engaging surface. The exposed pressure-sensitive adhesive forms a reclosable seal for the first and second panels.

The sealing structure may be applied to a flexible packaging for containing a product therein. A first flexible laminate sheet is provided preferably having a heat sealable material on the inner surface thereof. An opposing second flexible sheet is provided with a heat sealable material within an engaging portion thereof. The opposing sheet portions are sealed together to create an end seal for the package. A reclosable seal is formed as part of the end seal. The closable seal includes a pressure-sensitive adhesive applied to an inner surface of the first sheet under the heat sealable material. A separation line within the first sheet extends at least partially through the heat sealable material that is covering the pressure-sensitive adhesive, adjacent the end seal. The separation line causes the heat sealable material of the first sheet to separate from the first sheet upon application of an opening force to the end seal. The heat sealable material of the first sheet remains adhered to the heat sealable material of the engaging portion of the second sheet. The exposed pressure-sensitive adhesive forms a resealable seal for the open end of the package.

A method of making a flexible package having the structures is also contemplated by the present invention. The method and structure of the invention may be applied to a number of package forms.

### BRIEF DESCRIPTION OF THE DRAWINGS

For the purpose of illustrating the invention, the drawings show forms that are presently preferred. It should be understood that the invention is not limited to the precise arrangements and instrumentalities shown in the drawings.

FIG. 1 is a perspective view of a flexible package having sealed ends.

FIG. 2 is a perspective view of the package of FIG. 1, wherein one sealed end of the package has been opened to expose a resealable closure.

FIG. 3 is a partial cross-sectional view of the flexible package of FIG. 1 taken along line 3-3 therein.

FIG. 4 is a partial cross-sectional view of the flexible package as shown in FIG. 2 taken along line 4-4 therein.

FIG. 5 is a front elevation of an alternate form of a flexible package of the present invention.

FIG. 6 is a front elevation of the package of FIG. 5 with one end seal shown in the open condition and exposing a resealable closure.

FIG. 7 is a perspective view of a fin seal on a flexible package wherein the seal is opened and a resealable closure is exposed

FIG. 8 shows a front elevation of a further embodiment of a flexible package having the present invention provided therein.

FIG. 9 is a partial cross-sectional view of the top portion of the package of FIG. 8 as taken along line 9-9.

FIG. 10 is a perspective view of a still further embodiment of a flexible package having a lap seal and a resealable closure thereon.

FIG. 11 is a perspective view of the package of FIG. 10 with the flap portion shown in the open condition.

### DETAILED DESCRIPTION

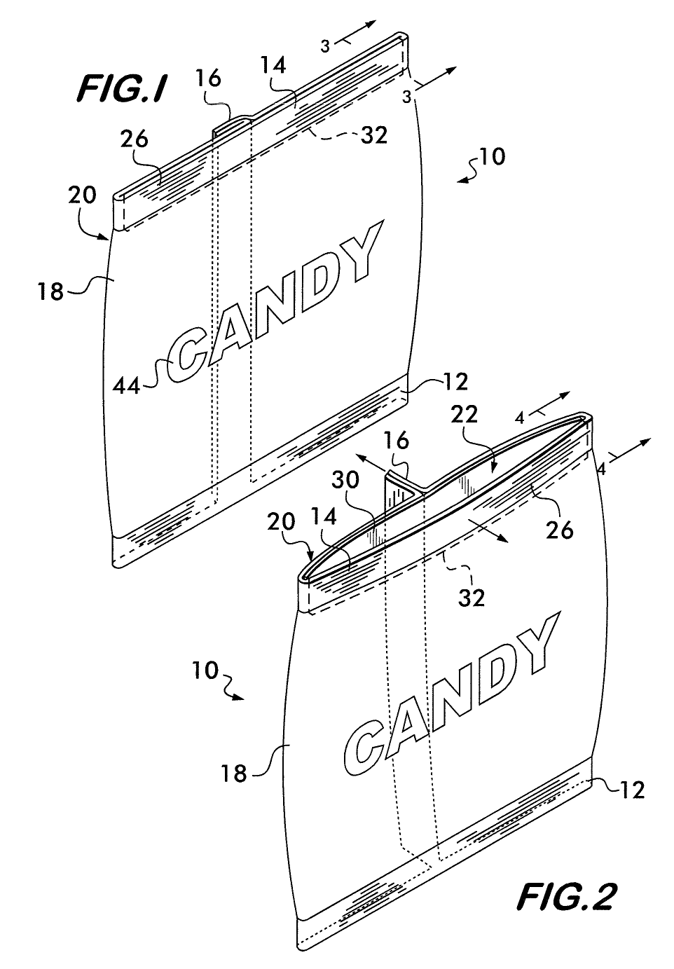

In the drawings, wherein like numerals identify like elements, there is shown a number of embodiments of a package. In FIG. 1, the package is generally designated by the numeral 10 and comprises a flexible laminate material sealed together to form an inner volume for retaining a product (not shown). The package 10 includes a bottom end seal 12, a second or top end seal 14 and a rearward or fin seal 16. Each of the original package seals 12, 14, 16 is preferably a heat seal of the type generally known in the art. Cold seal or hot melt-type closure methods may also be used to form a relatively permanent seal between a front panel or wall 18 and the rear panel or wall 20 of the package 10 (and the formation of the rear seal 16). In FIG. 2, the package 10 is shown in an open condition wherein the top seal 14 is separated to expose a resealable closure 22. The package 10 is opened by an opening force simulated by diverging arrows in FIG. 2. The resealable closure 22 is created proximate the top end seal 14.

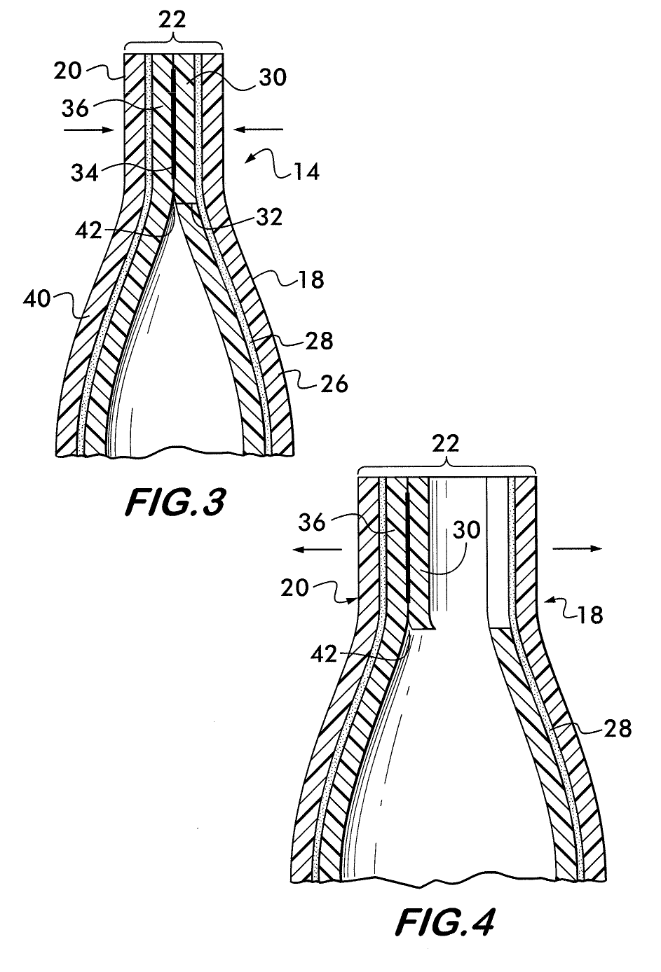

As illustrated in the cross section of FIG. 3, the front panel 18 comprises an outer ply 26 having a pressure-sensitive adhesive 28 formed on an inner surface thereof. Covering the pressure-sensitive adhesive 28 is an inner ply 30 formed of a heat sealable material. Inwardly from the end of the package 10 is provided an internal die cut 32, which penetrates the heat sealable material 30 but does not penetrate into the outer ply 26. The die cut 32 is inward of (in FIG. 3 positioned below) the formed heat seal 34. The heat seal 34 is provided between the heat sealable material 30 of the front panel 18 and an opposing portion of heat sealable material 36 on the rear panel 20. In FIG. 3, the package 10 is in the sealed condition, with the heat seal 34 adhering the front panel heat sealable material 30 to the rear panel heat sealable material 36. The heat and pressure applied by the sealing jaws of the heat seal mechanism are simulated by inward directional arrows. The amount of pressure and heat applied to form the heat seal 34 may vary with the materials being used and the desired strength of the seal, as is known in the art.

In FIG. 4, the opening force (identified by outward directional arrows) causes a separation of the heat sealable material 30 along the die cut line 32. The portion of the heat seal 34 formed by the inner ply of front panel 18 is removed from the pressure-sensitive adhesive 28 and remains sealed to the heat sealable material 36 of the rear panel 20. The die cut 32 forms a separation line, causing release from the front panel 18 of a portion of the heat sealable material 30 extending from the line 32 to the edge of the package 10.

Removal of the heat sealable material 30 exposes the pressure-sensitive adhesive 28 and creates the resealable closure 22. Prior to separation of the material 30 from the inner surface of the front panel 18, the end seal 14 has sufficient strength to store product within the flexible package during shipment and storage. As illustrated in FIGS. 1 and 2, the die cut separation line 32 extends across the width of the front panel 18 of the package 10. The separation line preferably extends to the side edges of the package 10 and may be directed upward, if desired. As shown in FIG. 3, the line 32 is spaced from the heat seal 34. Preferably, the spacing is about 0.125 inches. Thus, the die cut line 32 is adjacent the transverse edge of the heat seal 34 and the application of heat and pressure in forming the heat seal 34 does not alter the die cut 32. Preferably, the die cut 32 is applied in advance of the formation of the heat seal 34. A rotary die cut is contemplated to provide the desired precision. The die cut separation line 32 extends into the inner ply 30 of the front panel, but does not extend into the outer ply of the panel material. Penetration of the die cut in the outer ply could cause the front panel to rupture completely and fail to expose the pressure-sensitive adhesive.

Preferably, the die cut is positioned on one side of the package; thus, one portion of the inner ply within the heat sealed region will ride with the engaged portion upon application of the separation force, as shown in FIG. 4. Various materials may be used to form the panels of the package 10. The outer plies 26, 40 are preferably made of a polyester material. The heat sealable material 30, 36 on the inner plies of the package panels is preferably a polyethylene material, with the opposing surface made of compatible materials so as to form the required heat seal. Any pressure-sensitive adhesive having sufficient reclose strength may be utilized. The pressure-sensitive adhesive 28 may be pattern applied underneath the heat sealable material 30 in the area of the die cut separation line 32. Other types of adhesive may be utilized in the remaining portions of the package to form a more permanent bond or to create other features within the package, such as a clear window. An ink layer may be provided on the inner surface of the outer ply 26, 40 for purposes of making a decorative package. (See writing 44 in FIGS. 1 and 2.)

The package 10 in FIGS. 1 and 2 is generally formed in a tube having a rear longitudinal seal 16, sometimes called a fin seal. In this construction, the die cut line 32 is preferably provided on the front surface 18 of the package 10, opposite the fin seal 16. Thus, the heat seal material 30, which is removed from the pressure-sensitive adhesive 28 along line 32, is preferably sealed to the heat sealable material 36, which is positioned adjacent the fin seal 16.

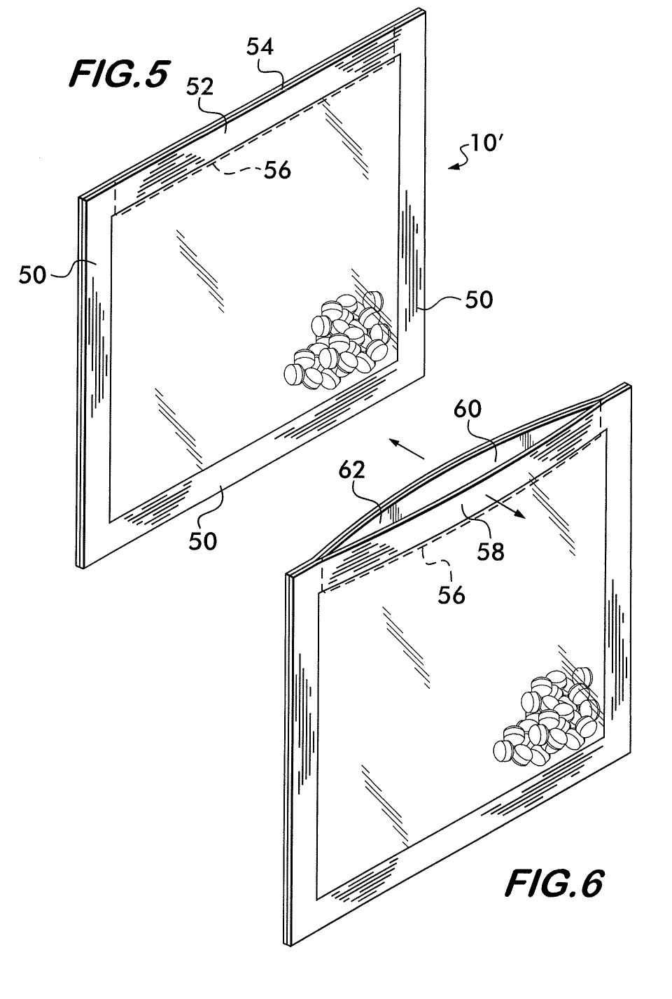

Other forms of packages having features of the present invention are illustrated in FIGS. 5-8. In FIGS. 5 and 6, a four-sided sealed package 10′ is shown. A permanent heat seal 50 is provided on the lateral side edges and the bottom edge of the package 10′. A top end heat seal 52 is provided along the upper edge of the package 10′. The end seal 52 includes a resealable closure structure 54, similar to that described in FIGS. 1-4. Thus, a separation line 56 is provided inwardly of the end seal 52 within the inner heat sealable material that forms a portion the front panel 58 of the package 10′. An opening force, illustrated by diverging arrows in FIG. 6, causes the heat sealable material on the inner surface of the package to separate along the line 56 and remain fixed to the inside surface of the rear panel 60 of the package, as illustrated in FIG. 6.

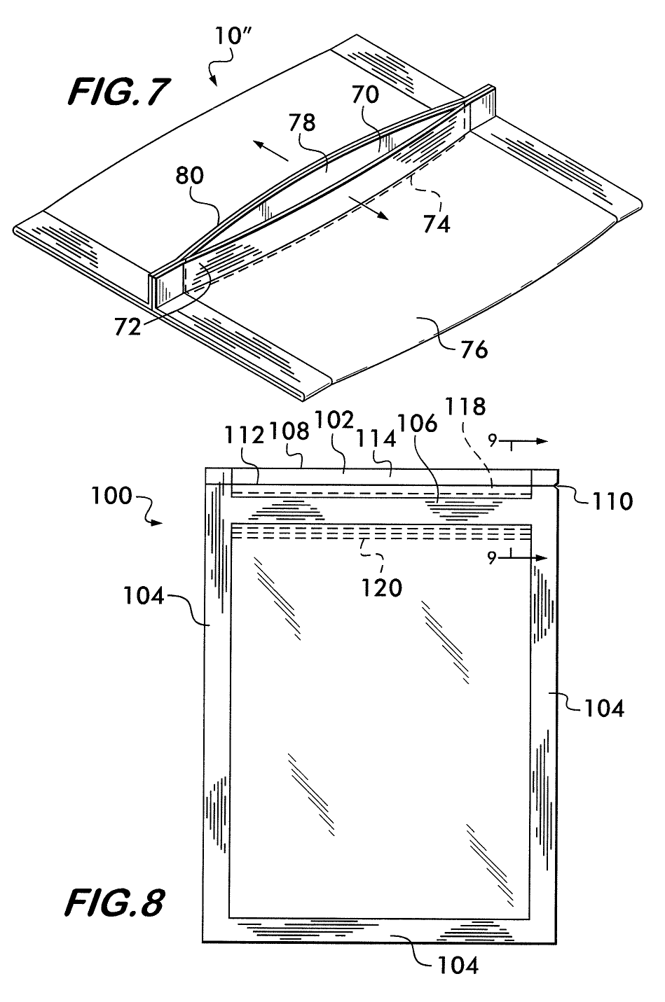

In FIG. 7, the reclosable seal 70 is provided on the fin seal portion 72 of the package 10″. A die cut line 74 is provided adjacent the fold in the rear surface 76 of the package 10″ at the base of the fin seal 72. An opening force, illustrated by diverging arrows, is provided transverse to the fin seal 72 causing a separation of the inner heat sealable material 78 along the separation line 74. Thus, the heat sealable material 78 rides with the opposite portion 80 of the fin seal 72 and exposes the inner surface of the fin seal in the region adjacent the separation line 74. The opposite sides of the fin seal 72 may be resealed and reopened as desired, due to the exposed pressure-sensitive adhesive.

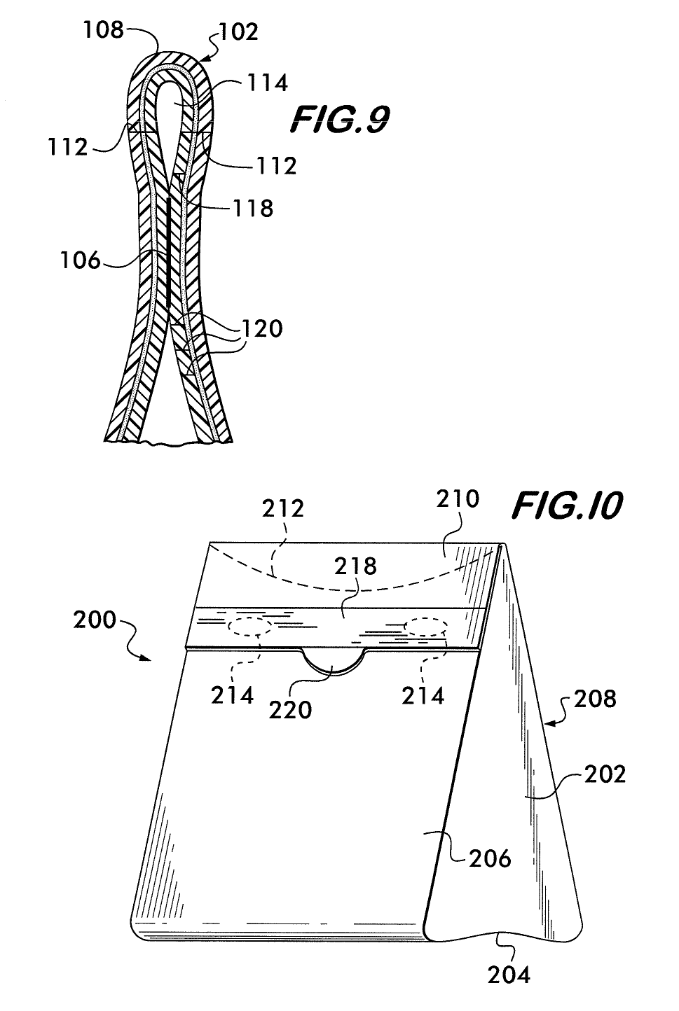

In FIG. 8, a flexible package 100 is illustrated having a tamper-evident seal 102 at the top end. The package 100 includes a three-sided permanent heat seal 104 on the lateral side edges and the bottom edge. An upper heat seal 106 is provided across the package, inwardly of the top edge 108. As shown in the cross section of FIG. 9, the top edge 108 is formed by a fold over of material. However, a further edge seal may be provided. A space 114 is provided below the top edge 108 and above the top heat seal 106. A notch 110 is provided in the side edge heat seal 104 with a tear strip or the like 112 extending across the package within the space 114. A die cut line 118 is provided between the tear strip 110 and the top heat seal 106. Multiple die cut separation lines 120 are provided below the top heat seal 106. The materials forming the package 100 are similar to those discussed above, such that inner heat sealable materials are fused together to form the top seal 106 and side seals 104. The die cut lines 120 are provided across the package 100 and are closely spaced with the top seal 106. To open the package 100, a tearing motion is provided, starting at the notch 110 and extending along the tear strip 112, removing the top 108 of the package 100 adjacent the space 114. Once the top is opened, tamper evidence is provided. The top heat seal 106 is then opened in the manner illustrated in FIG. 4, to expose the pressure-sensitive adhesive of the resealable closure for the package 100.

The multiple die cut lines 120 provide additional encouragement for the separation of the inner heat sealable material to expose the pressure-sensitive adhesive. The die cut 118 above the heat seal further provides for separation of the inner heat sealable material from the pressure-sensitive adhesive at the position of the top seal 106. Providing multiple lines 120 makes it more likely that the package will open adjacent the top seal 106, providing separation of the heat sealable material from the inner surface of the associated package wall.

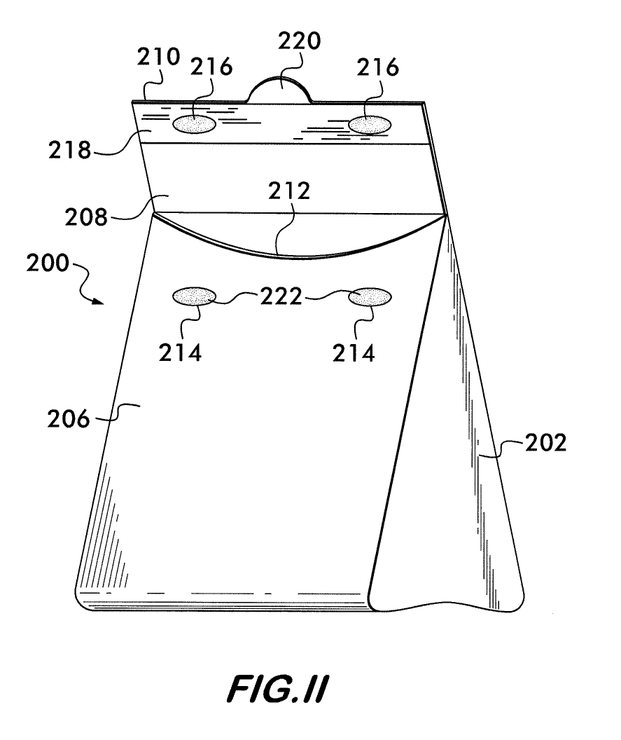

In FIG. 10, a flexible package 200 is illustrated having gusseted side walls 202 and a gusseted bottom 204. A front panel 206 of the package 200 extends between the side gussets 202, with a rear panel 208 provided on the opposite side of the package 200. A closing flap 210 is provided, covering the opening (see FIG. 10) defined by the top edge 212 of the front panel 206. The package 200 may be formed by a folded sheet of material making the front panel 206, bottom wall 204, rear panel 208 and closing flap 210, with the side gusset 202 sealed along the side edges. The package 200 is generally known as a lap seal-type arrangement. Other forms of the package may also be utilized with an overlapping front flap. The provision of gussets creates a stand up-type pouch.

As shown in FIGS. 10 and 11, the closing flap 210 is sealed to the front panel 206 of the package 200 to close the opening defined between the rear panel 208 and the top edge 212 of the front panel 206. A pattern applied coating 28 may be formed on the inside surface of the flap to create a peelable seal. The seal may alternatively be formed by heat, by a cold seal adhesive or by a similar bond. The coating 218 may be applied to a polyethylene or polypropylene material as may be desired or may be formed integral with the panel material. Two score line circles 214 are provided in the front panel 206. The score lines 214 penetrate the top portion of the panel 206, with an underlying pressure-sensitive adhesive provided underneath. The central area 216 within the score line circles 214 are sealed to the inside portion of the flap 210 along with the adjacent seal 218, surrounding the score lines 214. Alternatively, the score lines and underlying pressure-sensitive adhesive may be provided on the underside of the flap 210.

A lifting tab 220 is provided at the bottom edge of the flap 210. The tab 220 is preferably not sealed to the front panel 206 of the package 200 or is releasably sealed by a pressure-sensitive adhesive so that it may be removed from the package wall. Upon lifting the tab 220, a force is applied to the flap 210, causing the sealing area 218 to disengage from the front panel 206 of the package 200. The amount of seal created within the central area 216 defined by score lines 214 is sufficient to cause the central portion to adhere to the inside surface of the flap 210 and separate from the front panel 206. Removal of the central area material 216 is caused by separation along the score lines 214 and exposes the pressure-sensitive adhesive 222 within the laminate material of the front panel 206. Once opened (FIG. 10), the fixed seal 218 is no longer operational. However, the pressure-sensitive adhesive 222 within the front panel 206 provides a resealable closure for the flap.

The amount of the exposed pressure-sensitive adhesive 222 within the front panel 206 may vary as desired. A transverse bar may be provided (defined by transverse score lines extending from one side edge to the other) as contemplated in the other embodiments. In addition, the upper edge 212 of the front panel 206 may serve as an upper edge of the material removed from the package 200. If the seal 218 is to be in the form of a heat seal, the flap closure may be required to be made prior to final construction of the package, so as to avoid also sealing the inner surfaces of the package during creation of the seal 218. Further, a heat seal material is included on the outside surfaces of the package as well as on the inside surfaces so that the inside surface of the flap adheres to the outside surface of the front panel. A space is contemplated to be provided between the score lines 214 and the sealed area 218 and between the score lines 214 and the central sealing area 216. Dynamic registration of all of the score lines with the sealing area is required in order to create this spacing.

Although the invention has been described and illustrated with respect to a number of embodiments, it should understood by those skilled in the art from the foregoing that various other changes, omissions and additions may be made therein and thereto, without departing from the spirit and scope of the present invention.

What is claimed is:

1. A flexible package for containing a product, comprising:
a flexible sheet having a heat-sealable material on at least a portion of an inner surface thereof,
opposing longitudinal edge portions of the sheet sealed together to form a tube having first and second ends;
a first end seal formed proximate the first end and closing the first end of the tube; and
a second end seal formed proximate the second end and closing the second end of the tube; and
a re-closable seal formed adjacent the second end seal, the re-closable seal comprising
a pressure-sensitive adhesive applied to an inner surface of the flexible sheet within at least a portion of a first region proximate the second end of the tube and the heat-sealable material covering the pressure-sensitive adhesive within the first region,
the heat-sealable material applied to a second region of the second end of the tube facing the first region,
a separation line extending at least partially through the heat-sealable material covering the pressure-sensitive adhesive within the first region, the separation line positioned inwardly within the tube, adjacent the second end,
the heat-sealable material of the first and second regions being heat sealed together to form the second end seal, the second end seal forming a bond between the heat-sealable material of the first and second regions that is greater than the bond of the pressure-sensitive adhesive between the heat-sealable in the first region and the inner surface of the flexible sheet,
the separation line within the heat sealed material, upon application of a opening force transverse to the second seal, causing release of the heat-sealable material from the inner surface of the flexible sheet within the first region, wherein the heat-sealable material of the first region remains adhered to the second region heat-sealable material, and
the exposed pressure-sensitive adhesive forming a resealable seal for the package at the second end.

2. The flexible package of claim 1, wherein the separation line is contiguous with the first region and spaced from the second end seal.

3. The flexible package of claim 1, wherein the separation line is a die cut line.

4. The flexible package of claim 1, further comprising a pressure-sensitive adhesive applied to the flexible sheet within at least a portion of a second region of the second end of the tube, the heat-sealable material within the second region covering the pressure-sensitive adhesive.

5. The flexible package of claim 4, wherein the second region extends in a transverse direction to the longitudinal edge of the tube.

6. The flexible package of claim 1, wherein the separation line comprises multiple die-cut lines positioned inwardly within the tube, adjacent the second end seal.

7. The flexible package of claim 1, wherein the flexible sheet is made of a polyester material.

8. The flexible package of claim 1, wherein the heat-sealable material is a polyethylene material.

9. The flexible package of claim 1, wherein the formed tube comprises a longitudinal fin seal, a portion of the fin seal extending through the second region.

10. The flexible package of claim 1, wherein the formed tube comprises at least one longitudinal edge seal, the separation line extending perpendicular to the edge seal.

11. The flexible package of claim 1, further comprising a tamper evident seal formed adjacent the second end seal.

12. A package made from a flexible laminate material having inner and outer surfaces, the package having at least one heat sealed seam and defining an inner volume for retaining product therein, a re-sealable seal comprising:
a heat-sealable material provided on at least a portion of an inner surface of the flexible laminate,
a pressure-sensitive adhesive provided within flexible laminate and covered by the heat-sealable material within at least a portion of a first region of the at least one heat-sealed seam,
a heat-sealable material provided on a second region of the at least one heat-sealed seam, the second region facing the first region,
a separation line extending at least partially through the heat-sealable material covering the pressure-sensitive adhesive in the first region, the separation line spaced from and positioned inwardly of the at least one heat-sealed seam,
the heat-sealable material of the first and second regions being heat sealed together to form the at least one heat-sealed seam,
the separation line within the heat-seal material within the first region forming a separation line for the heat-sealable material upon application of an opening force transverse to the at least one heat sealed seam, the opening force causing release of the heat-sealable material from the pressure-sensitive adhesive along the separation line and within the first region, the heat-sealable material with in the first region remaining sealed to the heat-sealable material within the second region upon release of the heat-sealable material from the pressure-sensitive material, and
the exposed pressure-sensitive adhesive forming a resealable seal.

13. The package of claim 12, wherein the separation line is contiguous with the first region and spaced from the at least one heat seal.

14. The package of claim 12, wherein the separation line is a die cut line.

15. The package of claim 12, further comprising a pressure-sensitive adhesive applied within at least a portion of a second region of the second end, the heat-sealable material within the second region covering the pressure-sensitive adhesive.

16. The package of claim 15, wherein the second region extends in a transverse direction to a longitudinal edge of package.

17. The package of claim 12, wherein the separation line comprises multiple die-cut lines positioned inwardly, adjacent the second end seal.

18. The package of claim 12, wherein the flexible material is made of polyester.

19. The package of claim 12, wherein the heat-sealable material is made of polyethylene.

20. The package of claim 12, wherein the flexible material is formed into a tube and comprises a longitudinal fin seal, a portion of the fin seal extending through the second region.

21. The package of claim 12, wherein the formed tube comprises at least one longitudinal edge seal, the separation line extending perpendicular to the edge seal.

22. The package of claim 12, further comprising a tamper evident seal formed adjacent the second end seal.

23. The package of claim 12, wherein the heat-sealable material of the first and second regions is heat sealed together to form the second end seal, the second end seal forming a bond between the heat-sealable material of the first and second regions that is greater than the bond of the pressure-sensitive adhesive between the heat-sealable in the first region and the inner surface of the flexible sheet.

24. The package of claim 12, wherein the heat sealable material of the first surface of the fist layer is heat-sealed to the heat-sealable material of the engaging surface of the second layer to form the heat sealed seam.

25. The package of claim 12, wherein the at least one heat-sealed seam is positioned adjacent an edge portion of the package.

26. A heat sealed structure comprising:
a first layer having
first and second surfaces, and
at least one portion of the first layer having
a heat-sealable material defining at least one portion of the first surface, and
a pressure-sensitive adhesive disposed between the heat-sealable material of the first surface and the second surface within the at least one portion of the first layer, and
a separation line within the heat-sealable material covering the pressure-sensitive adhesive in the at least one portion of the first surface, the die-cut line positioned contiguous with an edge heat-sealed seam; and
a second layer having an engaging surface, at least one portion of the engaging surface having a heat-sealable material thereon,
the heat-sealable material on the first surface of the first layer being heat-sealed to the heat-sealable material of the engaging surface of the second layer to form the heat-sealed seam,
the separation line within the heat-sealable material of the first surface of the first layer forming a separation line for the heat-sealable material from the first layer upon application of an opening force to the heat-sealed seam, the opening force causing release of the heat-sealable material from the pressure-sensitive adhesive along the separation line, and the heat-sealable material of the first surface remaining sealed to the heat-sealable material within the engaging surface upon release of the heat-sealable material from the pressure-sensitive material, and the exposed pressure-sensitive adhesive forming a re-closable seal for the first and second layers.

27. A method for making a flexible package having a re-closable seal adjacent one end, the method comprising the steps of:
providing a flexible pouch having
an inner surface and an open filling end, the open filling end having a pressure-sensitive adhesive applied to a first region of the inner surface thereof, said first region adjoining a first edge of the open filling end,
a heat-seal coating applied over the first region of the inner surface, including the pressure-sensitive adhesive, and
a heat-seal coating provided over the inner surface adjoining an opposing second edge of the open end;
providing a separation line within the heat-seal material of the first region spaced inwardly along the first edge;
filling the flexible pouch with a material to be stored therein;
heat sealing the heat-seal coating of the first region to the heat-seal coating of the second region along the first and second edges, the separation line positioned within the pouch and proximate the heat-seal coating of the first and second regions.
